(19) United States
(12) Patent Application Publication
(10) Pub. No.: US 2012/0122570 A1
(43) Pub. Date: May 17, 2012

(54) AUGMENTED REALITY GAMING EXPERIENCE

(76) Inventor: David Michael Baronoff, Los Angeles, CA (US)

(21) Appl. No.: 12/947,439

(22) Filed: Nov. 16, 2010

(51) Int. Cl. G06F 17/00

(52) U.S. Cl. 463/31

(57) ABSTRACT

A persistent, multi-player game, most likely story-based, involving the use of a smart phone, cell phone and/or other wireless device (while remaining multi-platform in nature), where the gaming and story may be tied to the location of the smart phone, cell phone and/or other wireless device (while remaining multi-platform) as held by the human gamer (who may or may not utilize a customizable avatar), and where the smart phone, cell phone and/or other wireless device (and/or other platform) provides, among other things, video, voice, text and audio to the human gamer, thereby enriching the game and story and the gamer's interaction with his or her environment, including, perhaps, but by no means being limited to, other gamers, real world actors, the conversion of a person, place and/or thing into a game component via “augmented reality” technology, tradable items and/or sponsors.

### BACKGROUND

Augmented reality includes a meshing of real-life experience and a virtual experience. Movies often create an augmented reality effect, adding computer rendered graphics to recorded landscapes. However, this is done separately in a post-production studio. While techniques have improved over the years, originally, each frame of the recorded landscape may have been analyzed to ensure that as the landscape moved in a display area (e.g., as the camera recording the landscape moved), any augmented reality objects (e.g., the rendered graphics) moved correspondingly in relation to the landscape. Real-time rendering of an augmented reality presents additional difficulties. In the post-production setting, a person could provide decision input on how the rendered layer should move to naturally match the recorded layer's motion. However, this is not possible in a real-time setting, where the rendered layer may need to react instantly to the real layer's movement.

Solutions to real-time augmented reality have been under development, and are now becoming commercially available. For example, one solution for real objects (e.g., news anchors) and a rendered landscape (e.g., a news desk studio) is to put positional sensors on each studio camera. The landscape rendering engine may then receive input from the camera positional sensors and match the rendered perspective in real-time. This technique does not provide sufficient data for the overlay of a rendered object in a real landscape. In the rendered object situation, solutions may include identifying a set of markers in the landscape, and matching a corresponding set of markers (e.g., invisible points pre-designated) in the rendered object to those landscape markers. This way, if the rendered object is some number of meters from marker A at an angle of some other number of radians, the rendered object can be rendered in the same position in each frame, regardless of where the markers are in future frames. Further, if the angle between marker A and marker B changes, the rendered image may be rotated in view by the same degree of change.

Marker solutions may use fixed, known markers. That is, the rendering algorithm may be trained to identify certain distinct objects that are known to be present in the recorded landscape. For true real-time, ad-hoc landscape scenarios, there may be no known objects in the scene, or unexpected interfering objects may occur. Thus, a rendering engine may need to identify fixed points within the scene, without having prior training with those exact objects. In a similar manner, object detection may be required, such as identifying people in a landscape, buildings, books, or any other object. These tools are still in development, but rapidly becoming commercially available.

Some augmented reality (AR) tools and methods that are known in the art may be used to implement various embodiments of the present invention. For example, U.S. Patent Application Pub. No. 2007/0024527, METHOD AND DEVICE FOR AUGMENTED REALITY MESSAGE HIDING AND REVEALING discusses some known aspects of image recognition. U.S. Patent Application Pub. No. 2010/0045701 AUTOMATIC MAPPING OF AUGMENTED REALITY FIDUCIALS discusses some known aspects of image marker mapping. U.S. Patent Application. Pub. No. 2009/0054084 MOBILE VIRTUAL AND AUGMENTED REALITY SYSTEM discusses some known aspects of image identification, position determination, and multi-user AR sharing/experiences. U.S. Patent Application Pub. Nos. 2008/0194323, 2007/0035562, and 20090244097, each discusses, inter alia, technical aspects of AR known in the art. Each of these references are herein expressly incorporated by reference, except that with regard to any section, embodiment, or portion of any of the incorporated references that conflict with or are otherwise incompatible with the present disclosure, the present disclosure shall control.

Use of augmented reality technology for user games has been very limited. Games exist, but are very limited in scope. Example embodiments of the present invention provide novel methods and systems for a multi-player augmented reality experience.

### SUMMARY

Example embodiments of the present invention provide a persistent augmented reality game into which a user may log for obtaining an augmented reality gaming experience.

According to an example embodiment of the present invention, a computer-implemented method for providing a gaming experience includes: associating, by a processor, an element with geographic coordinates; receiving data, by the processor and from a user device, the received data indicating that the user device is located proximal to a geographic location corresponding to the geographic coordinates; and responsive to the received data, transmitting data, by the processor and to the user device, for rendering the element via an output device of the user device.

In an example embodiment, the element is at least one of a sound, a text, and an image.

In an example embodiment, the element is an animation element; the output device is a display device; the rendering of the animation element includes displaying the animation element in the display device and one of (a) overlaying and (b) replacing a rendering of a real-space object that is at the geographic location and that is sensed by the user device.

The animation element may be displayed in the display device conditional upon that the geographic location is within a viewing frustum of an imaging sensor of the user device.

The data received by the processor may further indicate the viewing frustum, and the data for rendering the animation element may be provided to the user device conditional upon that the geographic location is indicated to be within the viewing frustum.

Alternatively, the data for rendering the animation element may be transmitted to the user device when the data received by the processor from the user device indicates that the user device is within a predefined area drawn about the geographic location, prior to the geographic location being sensed by the imaging sensor, the user device locally storing the data for rendering the animation element and subsequently displaying the animation element in response to the imaging sensor sensing the geographic location.

The viewing frustum may be determined based on at least one of a sensed rotational position of the user device and recognition of an object sensed by the imaging sensor.

The animation element may be differently displayed depending on an angle of the user device relative to the geographic location.

Over time, the processor may dynamically modify animation elements to be associated with geographic coordinates, which geographic coordinates are associated with animation elements, and whether a user device receives data from the processor for displaying an animation element at a geographic location corresponding to particular geographic coordinates. Which animation element the data includes for display at the geographic location corresponding to the particular geographic coordinates may depend on a time at which the user device is indicated to be located proximal to the geographic location corresponding to the particular geographic coordinates. The processor may be configured for a plurality of user devices located proximal to geographic locations corresponding to a particular set of geographic coordinates to log-in to the processor for obtaining data including animation elements associated with the set of geographic coordinates for display of the animation elements in respective display devices of the plurality of user devices. The animation elements may be provided by the processor as part of an interactive game in which players operating the user devices obtain at least one of points, ranking, and game currency during navigation of an augmented reality in which the animation elements are displayed in the display devices of the user devices. A same animation element may be provided to two or more of the plurality of user devices that are simultaneously positioned such that a geographic location corresponding to geographic coordinates with which the same animation element is associated is within respective viewing frustums of respective imaging sensors of the two or more of the plurality of user devices. Due to the dynamic modification, it may occur that, for two or more user devices that begin the interactive game at different times at a same location with a same viewing frustum, an animation element provided by the processor to one of the two or more user devices for one of (a) overlay over, and (b) replacement of, a real-space object at a geographic location within the same viewing frustum is not provided by the processor to another of the two or more user devices. The dynamic modification may be responsive to player interaction with animation elements provided by the processor for display at user devices.

According to an example embodiment of the present invention, a computer-implemented method may include: obtaining, by a processor, data from each of a first user device and a second user device, the data indicating that the first and second user devices are located proximal to each other; and responsive to the obtained data, providing, by the processor, a gaming element for output at least one of the first and second user devices.

In an example embodiment, the gaming element includes respective gaming elements for each of the first and second user devices representing a player associated with the other of the first and second user devices. In an example embodiment, the gaming element displayed in each of the first and second devices dynamically changes in response to real-space actions performed by the respective player with which the other of the first and second devices is associated. In an example embodiment, the gaming element is provided conditional upon that a user associated with the at least one of the first and second user devices has a specified status. In an example embodiment, the gaming element is provided conditional upon that a user associated with the at least one of the first and second user devices at least one of (a) has reached a predetermined game level and (b) is assigned to a specified team. For example, with respect to the former, certain augmented reality game elements may be too advanced for beginners, for example, the beginner would almost certainly be defeated by an augmented reality creature, or is not advanced enough to be enough of a challenge to play against a representation of another player who has reached a more advanced game level. The system may therefore provide that the beginner is unable to experience the augmented reality object.

According to an example embodiment of the present invention, a computer-implemented method for providing a gaming experience includes: associating, by a processor, an element with an object template; and transmitting, by the processor and to a user device, data providing for output of the animation element in an output device of the user device responsive to matching of a real-space object to the object template.

In an example embodiment, the element is an animation element, the output device is a display device, the data provides for display of the animation element in the display device one of (a) overlaying and (b) replacing the real-space object matching the object template. In an example embodiment, the object template is one of a template of a furniture item, a template of a building, a template of an animal, a template of an outlet, a template of a lamp, a template of a person, and a template of sporting equipment.

According to an example embodiment of the present invention, a computer-implemented method for providing a gaming experience includes: obtaining, by a processor of a user device, data that includes an element and that associates the element with an object; outputting, by the user device, an instruction to move the user device such that the user device displays the object in a display device of the user device; sensing, by the user device, movement of the user device subsequent to output of the instruction; sensing, by the user device, that the user device has substantially come to a standstill subsequent to the sensed movement and that the user device remains substantially still for a predetermined time period; and responsive to expiry of the predetermined time period, the processor outputs the element.

In an example embodiment, the element is an animation element, the output of the animation element includes one of (a) overlaying the animation element over a focal feature that represents a sensed real-space object and that is displayed in the display device, and (b) replaces the focal feature with the animation element. In an example embodiment, responsive to the expiry of the predetermined time period, the processor records the focal feature in association with the animation element; subsequent to the recordation, object recognition is used to determine that a sensed real-space object matches the recorded focal feature; and, responsive to the determination of the match, one of (a) the animation element is overlaid in the display device over a representation of the sensed real-space object determined to match the recorded focal feature, and (b) in the display device, the representation of the sensed real-space object determined to match the recorded focal feature is replaced with the animation element.

According to an example embodiment of the present invention, a computer-implemented method for providing a gaming experience includes: obtaining, by a processor of a user device, data including an animation element that is associated with a sound; sensing, by an imaging sensor of the user device, a real-space area; responsive to the sensing of the real-space area, displaying in a display device of the user device a representation of the real-space area; sensing, by the user device, the sound; and responsive to the sensing of the sound, displaying, by the processor, the animation element in the display device and one of (a) overlaying and (b) replacing a portion of the representation of the real-space area.

According to an example embodiment of the present invention, a computer-implemented method for providing a gaming experience includes: obtaining, by a processor of a user device and from a server, an element associated with geographic coordinates; sensing, by the processor, that the user device is located proximal to a geographic location corresponding to the geographic coordinates; and responsive to the sensing, outputting, by the processor, the element in an output device of the user device.

In an example embodiment, the method further includes: sensing, by the processor, that the user device is located proximal to a geographic location corresponding to the geographic coordinates. Further, the element may be an animation element; the output device may be a display device; and the outputting may include displaying the animation element in the display device and one of (a) overlaying and (b) replacing a rendering of a real-space object that is at the geographic location and that is sensed by the user device.

In an example embodiment, the method further includes: providing a non-augmented reality based game for play on the user device; and, conditional upon at least one of (a) play of the provided non-augmented reality based game on the user device at least a predetermined number of times, (b) scoring at least a predetermined score by play of the provided non-augmented reality based game on the user device, and (c) reaching a predetermined level of the provided non-augmented reality based game on the user device, outputting on the user device a user-selectable link for joining an augmented-reality game in which the animation element is displayed, in which the processor dynamically changes display of animation elements as the user device changes location, and in which points are scored by a user performing a task also performed when playing the non-augmented reality based game.

In an example embodiment, the data obtained from the server identifies the association of the animation element with the geographic coordinates.

According to an example embodiment of the present invention, a computer-implemented method for providing a gaming experience includes: responsive to a combination of a sensed time of a clock and a sensed location of a user device, outputting, by a processor, an element in an output device of the user device.

In an example embodiment, the element is an animation element, the output device is a display device, and the outputting includes displaying the animation element in the display device and one of (a) overlaying and (b) replacing a portion of a representation of a real-space area sensed by an imaging sensor of the user device.

In an example embodiment, the clock is a clock of the user device.

In an example embodiment, the method further includes recording an identification of a geographic location as a user home, and the display of the animation element is responsive to satisfaction of a condition that the sensed location is the geographic location identified as the user home.

According to an example embodiment of the present invention, a computer-implemented method for providing a persistent multi-player experience includes: generating a persistent game-world using at least one of respective imaging data, respective auditory data, respective text data, and respective location information obtained from each of one or more of a plurality of smart devices via which one or more players interface with the persistent game-world; and based at least in part on the received location information, providing to the plurality of smart devices respective portions of the persistent game-world. Location information is generated based on output of respective spatial and optical sensors of the plurality of smart devices. The generating the persistent-game world includes enhancing at least one of the obtained imaging data and auditory data.

In an example embodiment, the method further includes providing output via the smart devices to engage the players with a plurality of game-world scenarios within the persistent game-world, the scenarios including both single-player and multi-player game scenarios.

In an example embodiment, the method further includes overlaying an animation element depicting an ally character on a generic physical form; receiving instructions from a player directed to the ally character; and providing a result of the character performing the instructions.

According to an example embodiment of the present invention, a system for providing a persistent multi-player experience includes: a server connected to a plurality of smart devices, each having a respective camera from which the server receives input, and each providing a respective mobile interface to the persistent multi-player experience; and one or more processors configured to augment image output of each camera to produce respective augmented reality (AR) displays including an augmented reality object displayed in a position and with an orientation consistent with respective viewing frustums of the respective smart device cameras.

In an example embodiment, the system further includes a device registered as a home base for a player.

In an example embodiment, geographic coordinates are stored and identified as corresponding to a home base for a player.

In an example embodiment, the system further includes an image recognition database, wherein the one or more processors is configured to identify objects from the input of the cameras based on matching of portions of the input with components of the image recognition database. In an example embodiment, at least one component of the image recognition database is one of a brand-partner product and a brand-partner advertisement, and a player associated with one of the plurality of smart devices from which input is received that matches the one of the brand-partner product and the brand-partner advertisement is responsively one of awarded an in-game credit and provided an augmented output.

According to an example embodiment of the present invention, a computer-implemented method for providing an augmented reality experience includes providing a story-driven augmented reality (AR) experience that includes a plurality of scenarios and objectives related to each other via the story-driven experience. The providing is on a smart device including a display, a processor, a memory, a network I/O device, an optical input device, and a plurality of sensor devices for sensing at least one of position, altitude, angle, distance, movement, sound, and time. The providing includes augmenting a display of a sensed image based on the at least one of the sensed position, altitude, angle, distance, movement, sound, and time.

In an example embodiment, the method further includes providing an augmented reality ally with artificial intelligence as a graphical overlay to an image of a sensed generic physical form.

In an example embodiment, the method further includes: providing the device user with instructions within the story-driven AR experience to perform a task; and performing object recognition based at least in part on the instructions given.

In an example embodiment, the method further includes providing, on a device, an interface to the story-driven AR experience, and the interface includes functions to establish a home base, acquire and deploy AR defense mechanisms, and communicate with other users.

In an example embodiment, the story-driven AR experience includes single player scenarios and multi-player scenarios. In an example embodiment, a plurality of players with which a plurality of smart devices on which the story-driven AR experience is provided are associated are divided into teams for team play.

In an example embodiment, the method further includes: receiving input from a user defining a new scenario; and providing the new scenario to a plurality of other users.

In an example embodiment, at least one game-world scenario includes providing clues leading a player to a physical location.

In an example embodiment, at least one scenario includes a multi-player scenario where an objective is achieved at a representation of a geographic location contingent on simultaneous input from a plurality of players, at least two of which are separated by a substantial geographic distance and at least one of the at least two of which being at the geographic location.

According to an example embodiment of the present invention, a computer-implemented method includes: in accordance with user input at a first device associated with a first game player of a game, generating an interactive object; obtaining and outputting, by a second user device associated with a second game player of the game, the interactive object; and, in accordance with interaction with the interactive object in accordance with user input a the second user device, modifying a game element of the second game player.

In an example embodiment, the step of modifying the game element includes one of modifying a score of the second player, modifying a level of the second player, and modifying a weapon of, or providing a weapon to, the second player, and modifying a tool or graphic object of, or providing a tool or graphic object to, the second player.

According to an example embodiment of the present invention, a computer-implemented method includes: in accordance with user input at a first device, associating a sound with a location; obtaining, by a second user device, the sound; and outputting the sound, by the second user device, responsive to the second device reaching the location.

According to example embodiments of the present invention, data including augmented reality objects, such as graphical overlays, sound, text, vibrations, etc. may be transmitted by a central server to a user device in response to data received by the server from the user device indicating a state in response to which the augmented reality object is to be output at the user device. The user device may, in response to receipt of the augmented reality object, output the augmented reality object. In alternative embodiments, the augmented reality objects may be preloaded at the user device prior to occurrence of the state responsive to which the augmented reality object is output. For example, the server may, in response to data from the user device indicating that the relevant state is imminent, transmit the augmented reality object to the user device, e.g., with data indicating when it is to be output. For example, if the user device is indicated to be near a location relevant for output of the augmented reality object, the server may transmit the object. The user device may then output the augmented reality object immediately in response to occurrence of the relevant state, without any delay due to transmission of the object. Alternatively, one or more, e.g., those output most often, or all augmented reality objects may be stored locally at the user device persistently, e.g., at least throughout game play. The user device may also locally store data indicating the appropriate states for output of the augmented reality objects. In an example embodiment, the stored data indicating the appropriate states may be updated by the server during game play.

In an example embodiment of the present invention, game rewards, such as additional powers/weapons, may be provided to a user in response to physical real-space tasks performed by the user.

Example embodiments of the present invention provide for a user's experience of the augmented reality environment to be affected by input obtainer from and/or at the user input device. Input may include location determined, e.g., based on GPS technology; time of day, measured based on a clock, e.g., of the user device or of the server, and/or location determined, e.g., based on GPS technology; sound obtained, e.g., via a microphone, the sound including for example, the sound of a passing train, singing, etc.; and light, e.g., via which to determine whether the device is in a light or dark environment, which information may be obtained, for example, via a light sensor.

### BRIEF DESCRIPTION OF THE DRAWINGS

FIG. 1A illustrates one example Augmented Reality (AR) display, according to an example embodiment of the present invention.

FIG. 1B illustrates a simplified wireframe version of the one example AR display of FIG. 1A.

FIG. 2A illustrates an example generic form, according to an example embodiment of the present invention.

FIG. 2B illustrates an AR overlay when viewing the generic form through an AR smart device, according to one example embodiment of the present invention.

FIG. 3 illustrates an AR scene, according to one example embodiment of the present invention.

FIG. 4 illustrates an example system, according to one example embodiment of the present invention.

FIG. 5 illustrates an example method, according to one example embodiment of the present invention.

### DETAILED DESCRIPTION

Example embodiments of the present invention provide a persistent, story-based multi-player game, involving the use of a smart device (e.g., cell phone, and/or other wireless device)—on one or more platforms—where the gaming and story may be tied to the location of the smart device, as held by the human gamer (who may use a customizable avatar). The smart device provides, among other things, video, voice, text, and audio to the human gamer, thereby enriching the story-based game and the gamer's interaction with his or her environment, e.g., with other gamers, real world actors, the conversion of a person, place and/or thing into a game component via “augmented reality” technology, tradable items and/or sponsors.

One example embodiment of the present invention may include a video game played in the real world through a networked smart device (e.g., an IPHONE®, PDA, BLACKBERRY®) (herein referred to as “the game”). The smart device may include any number of configurations, and may advantageously include a video lens, a video display, a microphone, a speaker, a clock, a light sensor, a wireless communication device (e.g., using Wi-Fi™, Bluetooth™, and/or cellular-based protocols), and a computer (e.g., including a processor, memory, etc.).

The game may include an introductory game, which may be local to the device or connected to a network, and which may be a single player game or a multiplayer game. During play of the introductory game, a test game may be provided. In one example embodiment, the test game may be a scheduled or user-triggered event in the introductory game, such as a bonus level, a final level, a hidden level, etc. In another example embodiment, the test game may be a randomly occurring event, e.g., the introductory game may be interrupted by the test game. In either of those example embodiments, the test game may have an objective, in which a player may either succeed or fail the objective. If the user fails, the game may return to the introductory game and/or may repeat the test game (e.g., either immediately or after further play of the introductory game). Upon successful completion of the test game, a user may be provided a plot-driven or narrative experience built in an augmented reality, including one or more of the examples and features described below.

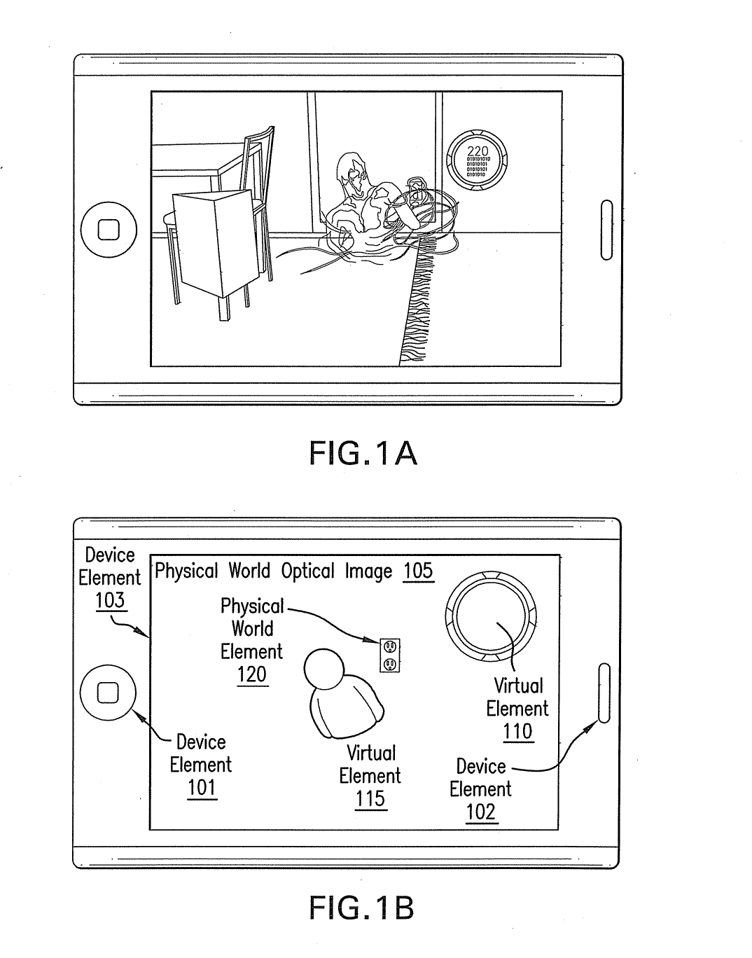

Object Interlacing: An element of example augmented reality experiences may include the interlacing or overlaying of virtual (e.g., computer generated) images over optically captured images, that is, real life images. A smart device may include an optical lens configured to capture video for a smart device display (e.g., an LCD screen). FIG. 1A and FIG. 1B illustrate an example of interlaced realities. The example device illustrated in FIG. 1B may include several hardware devices, such as an input button 101, an output speaker 102, and video display 103. The smart device may further include, e.g., on the reverse side of the smart device, an optical camera providing real world images to a processor, which in turn may provide a display image to the display 103. Among the many real world features captured by the device in image 105 is a standard wall outlet, illustrated as 120.

Within the video display 105, there may be several computer generated images. These may generally fall into two categories, elements that are independent of the real world elements, and elements that interact with or otherwise adjust based on real world elements. For example, virtual element 110 may be an information element, providing text and/or graphics about other aspects of the image and/or experience, while virtual element 115 may be an example of an interactive virtual element. Virtual element 115 may be a virtual character in the AR experience, invisible to the naked eye, but visible through the smart device. It may be overlaid and/or interlaced with the digital signal produced from the optical lens. Further, as illustrated in FIG. 1A, the virtual character may be interacting with physical world element 120.

To compensate for imperfections in the augmented reality, interactions between computer generated objects and physical objects, a whispyness trait may be given to some or all of the virtual characters. Characters, e.g., like the one presented in FIG. 1A, may have soft lines forming their structure, like a ghost character. When a character has very crisp outlines, its interaction with the physical world may need to be very precise. For example, if a virtual person stands on a platform, the position may need to be perfect to avoid the look of levitation or being stuck in the platform structure. When a character has softer outlines that illustrate an amorphous structure, there may be less visual need for precise positioning relative to the physical elements that character is interacting with.

Sensor Data: Retail devices, e.g., smart phones, offer an ever-expanding number of physical data sensors and inputs. Light sensors adjust screen brightness based on ambient light. Cameras capture images and video for storage, video conferencing, etc. Gyroscopes determine the relative angle of the device to a point of reference. Accelerometers determine various movements and direction of movements of the device. GPS devices determine geographic position and altitude. Clocks determine a time of day. Cellular communication signals and specialty hardware/software may also determine geographic position or work with GPS devices to determine geographic position.

Object Recognition: Object recognition can present one of the most difficult technical aspects of an augmented reality experience. Since example embodiments of the present invention are plot-driven experiences, the narrative may need to match the images in order to maintain an immersed experience for the user. In the storyline of this example embodiment, virtual element 115 may not merely be interacting with any object, but may be described to the user as an entity that consumes real world electricity by interacting with the common household electrical outlet. Thus, if object recognition fails to find an outlet, or incorrectly identifies the wrong object as an outlet, the user experience may be derailed from the storyline experience. Here, a common element may be selected to ensure the element exists in the vast majority of locations (e.g., the standard electrical outlet). Object recognition can be difficult as the size of the target object changes with lens zoom and physical distance to the object. Further, object shape and appearance changes based on angle to the object.

Advantageous to example embodiments of the present invention, the object recognition may be greatly enhanced by the story-driven experience, while maintaining the immersed environment. For example, a stand alone object recognition system may not be able to recognize a first-person perspective human wrist and fist when scanning a scene of unknown context. However, when a story-driven AR experience instructs a user on how to “weaponize” an object (e.g., the user's hand), by instructing the user within the context of the story to do a series of steps and then point the user's fist at the enemy virtual element in the video scene, the object identification algorithm may have a vastly better context by “knowing” that it is looking for the introduction of an object to the scene, and then matching that introduced object to the algorithm. For example, the system may determine that in a particular predefined context, certain recognized features are to be interpreted as a certain predefined object(s). This may be performed for any number of objects, such as a television remote, a book, a pillow, or any other object (e.g., preferred objects may be (1) commonly found in user environments, (2) easily identified by object recognition algorithms, and (3) generally safe for use).

Another object recognition feature of one or more example embodiments may include a specific pattern. The pattern may be found on items, cards, clothes, tattoos, or any number of other places. The pattern may be designed to help the object recognition system quickly and accurately identify an interlacing location. Each pattern may provide a special result. For example, temporary tattoos may be sold, distributed, and/or worn such that the augmented reality experience may identify that specific tattoo and animate a virtual creature (e.g., a three dimensional AR version of the tattoo image) that may perform some in-game task, provide information, or otherwise further the story-driven progression of the experience.

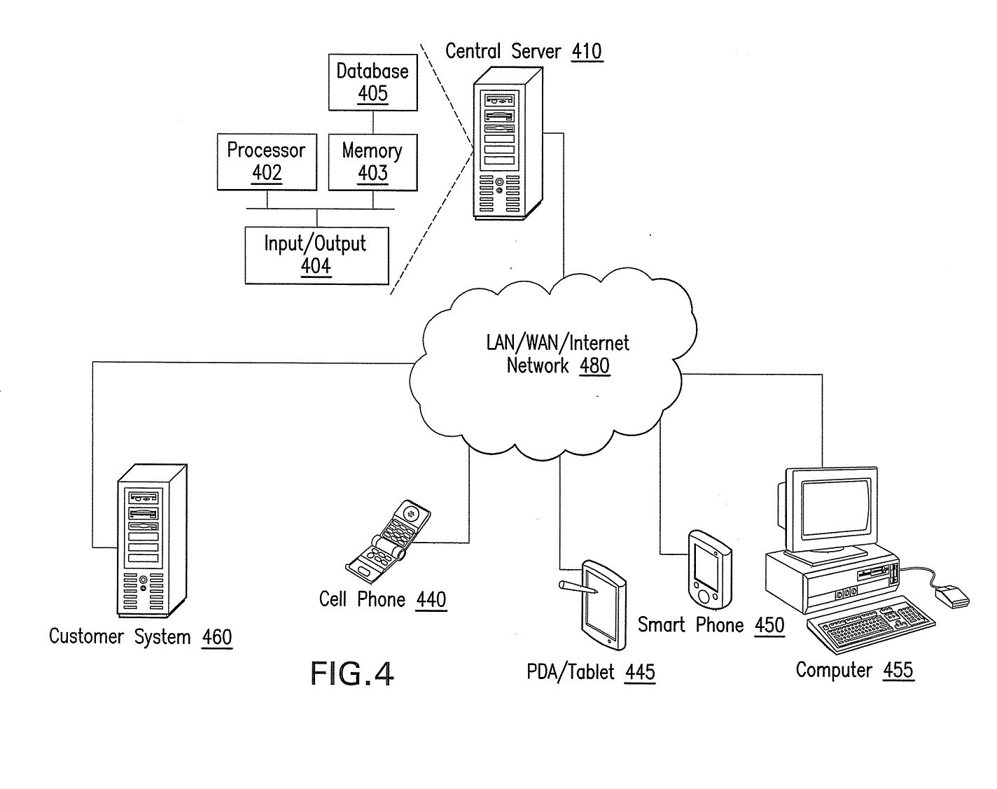

Digital Infrastructure: FIG. 4 illustrates one example system, according to an example embodiment of the present invention. The example may include one or more server computer systems, e.g., server 410. This may be one server, a set of local servers, or a set of geographically diverse servers. Each server may include an electronic computer processor 402, one or more sets of memory 403, including database repositories 405, and various input and output devices 404. These too may be local or distributed to several computers and/or locations. Any suitable technology may be used to implement embodiments of the present invention, such as general purpose computers. These system servers may be connected to one of more customer devices, e.g., cell phone 440, PDA/tablet 445, smart device 450, computer 455, or any other customer system 460 via a network 480, e.g., the Internet. One or more system servers may operate hardware and/or software modules to facilitate the inventive processes and procedures of the present application, and constitute one or more example embodiments of the present invention. Further, one or more servers may include a hardware computer readable medium, e.g., memory 403, with instructions to cause a processor, e.g., processor 402, to execute a set of steps according to one or more example embodiments of the present invention.

Data processing, e.g., event progressions, story-line control, graphics rendering, object recognition/matching, graphic interlacing, digital signal processing (DSP), etc., may need to be carefully distributed between the smart device (which may have a slower processing and memory capability) and a central server (which may have a large workload from many users, and a network latency delay between the server and those users). In one example embodiment, the bulk of the real-time processing (e.g., graphics interlacing and image processing) may be performed at the local device. Smart devices may have limited processing and memory capabilities as compared to desktop computers, but most data-enabled devices should provide sufficient resources for implementations of example embodiments, and any smart device capable of facilitating the example features described herein may be used in conjunction with the various example embodiments.

State data, to store a user's progress in the experience, may be saved at a central server to provide a persistent context for a user, and also allow a single user to utilize multiple smart devices for the experience. Additionally, multi-player interaction may also use the central server as an event clearinghouse to synchronize all the players of an area, in addition to synchronizing the global experience. In some multi-player instances, a central server may not be needed. For example, when devices fall within a single WiFi zone, or are close enough to each other for local protocols such as Bluetooth®, the example embodiments may use or partially use a peer-to-peer communication design, and cut out any or most network latency. For example, each of two player devices may recognize that the two devices are proximal to each other and may locally generate, for example, an interactive display object to represent the user of the other device, without use of the server. However, such objects would not be recognizable by other user devices logged-into the game. In an example embodiment, one or both of the user devices may transmit to the server an update concerning the interaction, e.g., once a duel is completed.

Much of the processing may need to be performed at the user device level, because, while the smart device may have less processing resources than the networked servers, the device resources may be faster than delays caused by network latency and transmission delays. This may typically be the case when the amount of data to be processed is similar to the amount of data that needs to be transferred to the processor, e.g., image processing. However, for features where transmission data is much less than processing data, the central server may be tasked with part or all of the processing load. One example of this may be object recognition. The local device may map an outline of the current camera image (or otherwise capture an image, including a full resolution image) and transmit that image to the central server. The central server may then generate a skeleton map, and identify certain feature markers (e.g., if this step was not performed at the device level) and then compare that with a database of possible object matches. If a match is found, the central server may provide data about the identified object and where in the image that object was identified. The transmitted data may be relatively little (e.g., a single image capture or pre-processed map of the image capture and resulting meta-data about any matches), while the actual searching may reference an enormous amount of stored object data and the matching may include processing the matching algorithms against that data. The object identification features may accordingly be distributed to the central server for processing.

Additionally or alternatively, certain AR functions may perform better at the server side, which may create noticeable latency in the flow of the experience. In this context, the narrative aspect of the story-driven experience may be used to diminish an impact of delay. For example, users may be instructed to scan their surroundings. The example experience may need to process images of the surroundings for object identification, in order to advance the story-driven experience. A user may expect the AR narrator to recognize a particular object (e.g., a household electrical socket) instantly, much the same way the user would. However, it may be required for the coded experience to run a complicated object recognition image processor, which may be very time consuming at the device (due to slower processing speeds), or very time consuming at the server (due to data transmission (network) latencies between the device and server). Either way, this deficiency of the technology—presenting a real-time thinking character with hardware that cannot fully support the Artificial Intelligence (AI) in real-time—may degrade the experience.

The narration may provide a story-based compensation for latencies. For example, for a story-line where there are characters invisible to the eye, but seen through the device, there may be a latency while standard images are being uploaded to object recognition servers with reference maps of the objects returned to the device. During the latency period, the system may inform the user that an energy detector is reading energy from the surroundings to sync up in-phase with otherwise unseen objects. Once the image processing has completed, and the smart device receives the results of the object recognition processing, the narration may inform the user that the phase-sync is complete, and then begin augmenting the identified objects.

Certain processing steps may be alternatively performed locally at a user device or at the central server. For example, it may be desirable for a processing step to be performed at the user device, to avoid transmission delays between the server and the user device. However, it may occur at times that the user device is overburdened with other processing, such that the system may dynamically determine that the processing step should instead be performed at the central server. According to an example embodiment, the system may further determine, e.g., based on a current connection whether the transmission delay is so long as to cause the system to appear as though it is hanging. If the result of the determination is negative (it is not too long), then the system may proceed from a first part of the narrative, provided before performing the processing, directly to a second point in the narrative following the processing. On the other hand, if the result is positive (delay is too long), then the system may switchover to an intermediate filler narrative for the duration of the processing. For example, the intermediate narrative may be output showing that a virtual system is scanning for weapons or filling up on power, etc. Thus, the system may dynamically determine whether to output a segment of the augmented reality environment based on current actual or estimated system latencies.

As an additional example, it may be known to the user that a certain virtual item is in a certain location, e.g., an AR defense trap the user set in a home base (e.g., the bedroom). When a user views this area through the smart device, the user may expect to see the AR item instantly, just as the user expects to see the real camera image instantly. However, the device may need a few moments to orient itself and render the correct overlay for the area. Thus, again, the narration may be used to protect the integrity of the experience. For example, the AR viewing feature of the device may be a two step process. First, the user indicates a desire to activate the AR viewer. Next, the narration may delay the user by presenting some graphics, providing information, or any other way. For example, the narration may provide a warning screen that indicates prolonged exposure to AR entities may be hazardous, and then inquire if the user wants to continue. Simultaneously, the smart device may begin the process of identifying the location and rendering the correct overlay. The user-selectable “continue” option (e.g., a touch screen button) may not appear until the rendering is complete (or nearly complete). Once the processing is finished, the second activation button may be shown, which may provide instant AR presentation upon selection. Here, any processing time is not intrusive to flow. Since the processing time does not fit within the story, providing an immersed story-driven experience may require concealment of this, along with any other requirements of reality that do not fit within the story-line of the augmented reality.

FIG. 4 is only one example embodiment, and different implementations and different scenarios may require alternative hardware, software, and network distributions. For example, user experiences may occur on gaming consoles, or partly occur on gaming consoles.

Multiplayer Tasks: In one example embodiment, users may engage in an experience with other users. This may be a progression from the single player portion of the game, or a starting point for a game experience. For example, a user may be given single player tasks in the current location, and subsequent to completing the single player tasks, the user may be informed of other user-characters in the experience's environment. Single player tasks may provide the advantages of local (e.g., in house) activity and environment training, both for the user and the AR algorithms, but may eventually lead to massively multi-player AR experiences. In this respect, a Global Positioning System may play an important role.

For example, a central server may identify that a user is located near an ongoing pre-planned multiplayer event and begin procedures to bring the user to the experience and engage in participating with the experience.

Multiplayer Event Missions: Multiplayer events and scenarios may, include any number of things, and some examples are given herein. Some multiplayer scenarios or events may be pre-programmed around a certain location, or a certain type of location, and be triggered when a certain number of active users are in the vicinity. For example, there may be a loose monster scenario programmed for various major public parks. While some example implementations may lead players to a multiplayer location as part of the story-driven experience, other scenarios may be independent of a story progression, and be triggered whenever a certain number of active players just happen to be in the location.

Such events may have multiple variations. For example, if 100 users are within a quarter mile of a location, the expected value for participation may be 10 users. However, the scenario may, have modifications to accommodate all 100 users, 50 users, 2 users, or only a single user. In some instances, certain participation levels (e.g., over 50 or under 2) may be incompatible with the scenario, and alternatives in these instances may be a narrative explanation as to why the scenario will not be engaged. For example, if there are 100 users, the example scenario may alert all 100 users of the danger and provide instructions. If only one user responds, while the other 99 ignore or decline, the AR engine may provide narration informing that one user that it was a false alarm, or the creature escaped, etc.

Multiplayer Interactions: Multiplayer interactions may occur in a number of ways. First, multiplayer scenarios may require ad hoc teamwork to accomplish a certain task (e.g., as described above). Second, multiplayer interactions may be indirect, such as deploying an ally to kidnap, fight, meet, or perform any other interaction with another's ally creature (e.g., as discussed further below). Contentious interactions may be direct, such as user against user AR challenges. Multiplayer interactions may include formalized teamwork, and team against team AR challenges.

For example, the example experience may provide multiple factions within the storyline, assigning users to certain factions, or allowing users to join certain factions as a natural progression of the story-driven experience. These factions may support a mutual defense plan/structure, claim territories, defend territories, and perform other tasks as a team, or within subsets of the team.

In an example embodiment of the present invention, a server selects those of available users to form each of the respective teams. The system may allow for a user to switch teams, e.g., by simple request and/or by performing certain tasks.

Teams may have added functions and features, e.g., such that members of one team are able to experience different augmented reality environments than members of another team, even at the same time and place. For example, teams may be able to leave hidden messages that are visible only via smart devices via which fellow teammates have signed into the AR experience. Teams may be able to mark their territory with AR graphics, writing, graffiti, etc., so other teams know that trespassing will be met with resistance. In addition to defense mechanisms and structures installed at a home base, defense mechanisms or structures may be installed anywhere. For example, a team may create an AR minefield in a certain area. They may mark the field to deter trespassing, or they may mark the field with a message visible only to teammates, so that teammates know how to traverse the field safely, while other teams set off the mines. This may have consequences such as the loss of AR items carried by the user, loss of an ally creature that is accompanying the user, loss of energy associated with the user (e.g., the loss of the hand weaponization ability discussed above).

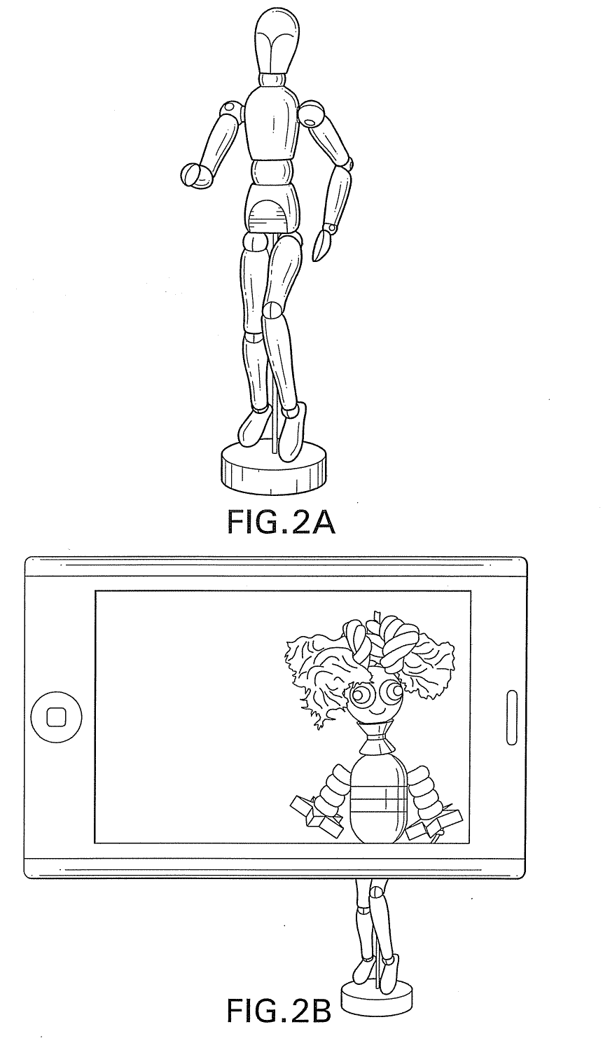

Enhanced Ally Creature: Users may be able to acquire a physical toy/character/ally type item. The ally may be sold in stores, over the internet, or may be distributed as part of one of the scenarios, either for free or a fee. The creature may be a generic form, such as the figure illustrated in FIG. 2A. The figure may also include a series of markers to assist the augmented reality engine in identifying the figure, along with the current angle and distance the figure is positioned, relative to any device running the AR engine. Each user may then see an AR character when using their smart device to view the figure, e.g., as illustrated in FIG. 2B. In one example embodiment, only one generic figure (e.g., FIG. 2A) may be provided to each user, while a great number of AR characters (e.g., FIG. 2B) may be provided as an augmentation to the generic figure. Users may be provided tools and options for customizing their character, replacing their character, and creating characters. The AR characters may also change as part of the AR experience, e.g., as a result of scenarios or scenario events. Additionally or alternatively, several basic generic figures may be provided, e.g., a humanoid figure, a canine type figure, a larger animal (e.g., tiger/lion/panther) type figure, and each generic figure may be associated with a plurality (even infinite plurality, e.g., by allowing user modifications and/or randomly generated feature combinations) of AR overlay characters. Additionally, in an example embodiment, a particular object is not required. Instead, the system may, store object profiles describing significant object features, and any physical object having such features may be matched by the system to the profile to provide the described functionality. For example, an object matching a stick profile may be associated with a light saber or sword.

Ally characters may be used in example scenarios, may provide clues to users (e.g., act as a scenario guide), and/or may perform tasks while the user is idle or otherwise not engaged with the AR experience. For example, characters may “retreat” nightly to their alternate world, and return with information, weapons, items, power-ups, or any other in-game resource. This may be determined by the system as something necessary for progression in the AR experience (e.g., a needed key, or a needed hint to yesterday's failed mission, or a helpful weapon to defeat and enemy that the user could not previously defeat, etc.), or the item may be randomly determined (e.g., a lottery system for daily in-game items). The ally character may accumulate the items, or may hold onto only one item at a time, forgoing future item acquisitions until the user collects the current item. This may encourage at least daily interaction with the example experience. Ally characters may also be used to send messages to other human users, and/or transfer in-game objects from one user to another.

The Ally character may join the user in the AR world. This may include the user bringing the generic physical figure (e.g., FIG. 2A) on example experiences, where the AR character (e.g., FIG. 2B) participates. Alternatively or additionally, the virtual character may be able to separate from the physical figure, and move about the virtual world independent of the physical figure. This may provide more flexible options for use of the character. Retrieving special items every night is one example of this, but other, more user interactive examples may also be implemented for the ally character. For example, the ally character may be kidnapped by another player, another player's ally character, and/or a character of the experience. A user scenario may include having to find and rescue the user's ally character.

Ally characters may also engage in their own storylines. They may have plot lines seemingly independent from the user associated with that ally character. Users may be able to visit their ally character in the virtual world (e.g., via the AR experience or via a portal experience into a purely virtual world). A user's smart device may provide the option to “see through the ally character's eyes,” where the user is essentially viewing and/or playing a purely or mostly virtual game/experience (as compared to augmenting reality, this portion may be confined to a virtual reality representing the ally character's parallel universe). Other viewing angles; options, and scenarios are also possible for the user to watch and/or interact with the ally character. For example, a user may be able to deploy the user's ally character to kidnap another user's ally character. The success of that operation may be determined by the two ally characters fighting (which may be determined by story-line, code, randomizers, in game objects/attributes, etc.). The user(s) of one or both of these fighting ally characters may be able to watch this animated content on the user's smart device (either as a pure graphic, or AR of a real landscape), home computer/laptop, or any number of other devices used within the example scenarios. Additionally, the user may be able to control the ally character, in both the virtual world via a command center (described below), in the real world via the command center, and in different ways in the real world via the smart device.

In an example embodiment of the present invention, instead of an ally, the physical item may be used to provide the user with some other game item. For example, the physical item may be used to generate for the user an animated wallet in which to store game currency, or to obtain a holder for weapons, or to obtain a weapon such as a sword, etc.

Home Base Tasks: A user may establish a “Home Base,” (e.g., the user's bedroom, office, whole house, whole property, etc.). In certain example embodiments, the home base may include a desktop computer, which is discussed further below. Home base tasks give a user a steady supply of story-driven scenarios and experiences without having to leave the user's home, for those who are not in a multi-player area and for those times between public-space scenarios. A user may need to establish defenses at the home base, such as force fields for windows, extra locks for doors, sensors, cameras, weapons, traps, and any number of other AR and/or virtual item. A user may be given status reports at a desktop control panel or on the user's smart device. For example, a user may be told, when the user wakes up, that some number of enemy creatures were captured in AR traps over the night and need emptying/resetting. Creatures may be general enemies or belong to other opposing users. In either case, captured creatures may be eliminated, sold back to the original user, or swapped for captured “friendlies.” Home base items may be defensive or offensive.

In one example scenario, discussed further below, a user may face a home base challenge, such as a black hole opening near the user's home, which may need continuous but intermittent attention. For example, a user may purchase a black hole reducing tool that shrinks part of the anomaly when applied for a certain period of time. This tool may be a laser type device on a turret, where a user may set it and leave it to shrink some section for a day or two, but then return to move the aim or recalibrate settings, etc. The anomaly may grow over time (e.g., unless held back by the user's efforts), and may have greater and greater negative effects as it grows. Further, enemy creatures may try to stop the prevention of the anomaly, and more and more enemy creatures may arrive at the home base location, which may require more and more home base defenses. Those defenses may be sold for real money, in-game currency, and/or acquired through in-game actions, which may provide a steady stream of revenue and/or user interactions.

Desktop Interface: Another user experience may include a less mobile device and/or interface. Game interfaces may be associated with a home computer or laptop computer, and may provide another set of experience interactions. It may be that the desktop interface is similar to, or includes similar features as, the smart device interface. Additionally or alternatively, the desktop interface may include only a few features similar to the smart device interface, and provide several functions unique to the desktop interface experience. The desktop interface may focus more on functions themed around economics (item trading), customization (character modification/configuration), inventory control (item activation/storage), planning (map access, mission briefings, player to player communication, team organization/forming, etc.), and interfacing with a purely virtual world portion of the experience.

A primary function of a desktop only interface may include establishing and customizing the home-base experience (e.g., as described above). The desktop interface may present a “command center” interface, with base-defense and scenario information/communication. By reserving some functions for the home desktop interface, the user may gain a greater feeling of an independent virtual world that is accessed by multiple tools, as compared to just a faster/big version (desktop) and a slower/small version (smart-phone) of a game. It may also allow users who are not able to participate in the broader AR experience, to still have substantial interaction with the overall experience.

Desktop interface functions may include single player scenarios and multi-player scenarios. For example, in one scenario, a user may be informed that some set of ominous events are occurring and/or will occur at their home base. Examples may be an invasion, a burglary of game items, and/or characters are trying to open a portal nearby for an invasion. The user may then have to frequently (e.g., daily) interact with the command center interface to set traps and defenses, as discussed above. They may have to often work on keeping the portal closed, and capturing any creatures who manage to get through the portal. An example multi-player scenario may operate independently, or may naturally stream from the single player scenarios.

For example, if a player does not log into the command center for some number of days (e.g., 5), the user may be alerted that the portal is almost fully open, his or her traps are all full, and a large/dangerous creature made it through the portal the prior night. The user may be informed that the creature escaped and is running lose. The creature's location may be local, and the player may be sent to capture the creature using the smart device and attributes above. Alternatively, the user may indicate an inability to pursue the creature at the moment, and scan for other users in the area of the creature. Those users may then be contacted by the game experience and/or first user, and informed of the virtual emergency, for which the first player needs help. One or more of those users may engage in a single player or multi-player scenario for catching the creature. The first user may turn the operation over to the other users, or may stay involved from the command center (e.g., desktop interface).

The first user may be able to watch various video feeds from the other users' smart devices, may be able to see tactical information, such as location and status of the creature/other-users, may be able to communicate with those users (e.g., providing tactical information and support), and/or may be able to provide in-game items to assist those users. The first user might also offer in-game currency or items as an incentive for other users' participation. The first user might do this out of a sense of responsibility for letting the creature lose, or because the user may, face consequences for failing to contain the creature (e.g., demotions, in-game currency fines, etc.).

In addition to giving the onsite users tactical information/support, or as an alternative interaction, the user may be provided with a virtual interface to a mobile weapon/vehicle/defense. For example, in addition to buying home-base armor, defense traps, and other virtual upgrades, the user might have purchased and/or otherwise acquired, a virtual military helicopter. The creature may be downtown, only a few miles away, and the user (either as a single player or in support of the onsite users) may be able to control the helicopter from the command center interface. The user may interface with a flight simulator to take off, traverse the distance to the creature, and engage the creature with weapons or traps, etc. The example experience servers may also know approximately where each onsite user is located, and render those users' participation in the first user's flight simulator window. At the same time, the AR rendering engines of the onsite users may render the virtual helicopter in the smart device viewer (e.g., the helicopter being from the other universe is only visible through the special functions provided in the smart device).

Other example virtual vehicles may include cars, trucks, tanks, submarines, etc. and may all also be purchasable assets for a user to virtually control via the command center. Each may have pros and cons, such as speed, armor level, weapon power, non-lethal capture abilities, cost, range, etc. Additionally, some virtual vehicles/weapons may require multiple users to operate. A helicopter may require a pilot, and a side gunner, or co-pilot. This may be performed by another user, at another desktop interface command center.

Additionally, a vehicle's range may be limited. For example, even if a helicopter from the parallel universe does not require fuel, it may have a speed limitation (e.g., 200 miles per hour). If a scenario is 100 miles away and takes 30 minutes, the onsite users will be finished with the objectives before the virtual vehicle can arrive. The example experience may therefore provide virtual warehouses, motor-pools, garages, hangers, etc. These may be located at strategic places, or any place a user sets them up. This way, if a user is in New York, and their creature runs to Seattle, Wash. they may still participate via the fighter jet they keep in Portland, Oreg. In other examples, the creature may have traveled a great distance and the user may have no way to get there, which may require the help of other users.

While example experiences may provide unlimited private hangers, certain example embodiments may implement a motor-pool structure. For example, a user does not necessarily purchase and store the user's own vehicle, but may contribute to establishment and upkeep of a one tank motor-pool for the New York area. This may be cheaper and more efficient, especially when actions are occurring at several different locations, and the user has multiple motor-pool shares (e.g., could participate in one of several areas). An advantage of the motor-pool, for an AR implementation perspective, may be to limit the number of virtual characters in a scenario. For example, if there are five tanks in the pool, the sixth user to come online to support the scenario through the virtual vehicle interface, may be told all the assets are gone, and that the asset request of the sixth user has been queued for when an asset becomes available. Assets may also have multiple roles.

For example, a helicopter side gun may remain dormant during single-player use, may be controlled by the single-user who is also the pilot, or may be controlled by an Artificial Intelligence (AI) during single-user use. The sixth user coming online may then be queued, but also take control (from the single-user with permission or the AI with permission or without permission) of the side gun, or other secondary job on the vehicle. This may still limit virtual entities, but allow more user engagement. Limiting virtual entities may help hide the stress these entities put on onsite players' smart devices, and prevent the AR game from becoming saturated by virtual entities, undesirably rendering the onsite players a marginal aspect.

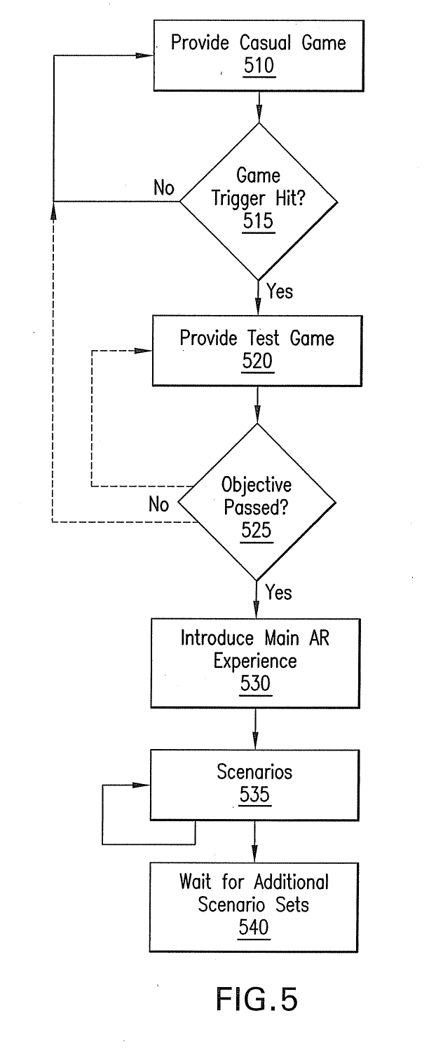

Example Experience: One example embodiment of the present invention may include a multi-scenario experience, as outlined in FIG. 5. At 510, the example method, may provide a first casual game, where players may interact with other players, or perform operations as a single player. During play of the first game, a game trigger may be hit at 515. This game trigger may be activated by the user (e.g., by accomplishing a certain task/level/goal), or may be activated by the system as an interrupt, e.g., randomly. Once the game trigger is hit, the user may be provided a test game at 520. This test game may be related in theme to a main user experience that is only reached upon completion of the test game. The test game may be provided as a training exercise or skill test for the user. If the user fails the test game, the user may be given more chances to interact with the test game, e.g., as illustrated by the first dotted line, or may be sent back to the first casual game at 510, e.g., as indicated by the second dotted line. These examples provide two options, and alternatively, the test game may be structured such that a player cannot lose, and must advance to 530.

Similarly, in an example embodiment of the present invention, the user device may include a non-augmented reality game in which certain user skills are used to play the game. During play of the game, e.g., in response to the user reaching a certain level or score, or after a certain number of games or amount of time played, the user device may output an invitation to join an augmented reality game in which skills honed during play of the non-augmented reality game may come into play. For example, the non-augmented reality game may be Brick Breaker, and the augmented reality game may include a scenario where the user is required to play a version of Brick Breaker at a particular location where the bricks are displayed as though emerging from a real-space object at the location.

At 530, a user may be introduced to the story-driven main experience. For example, the user may be told that the test game was a recruiting instrument to identify sufficiently skilled users to join an important mission. The story may center around a world invisible to human senses, but visible through “special” instruments downloaded to a smart device, e.g., cell phone. Consistent with the story, the user may then be given a series of scenarios at 535, e.g., as discussed above. For example, a scenario set may drive the story by introducing plot aspects, and providing a game experience to match. Initially, a user may be asked to view the user's television through the smart device. By guiding the user with the story aspects, the object identification mechanisms may function with more accuracy, while not distracting the user with false actions. For example, here, the user is directed to point the smart device at the television. The device sensors and image processing device may determine that the device is moving, and then stops for some pre-determined minimum amount of time (e.g., three seconds), and may then presume the current camera image includes a television. The object identification algorithm may then identify the object most likely to be a television, based on skeleton structures and indicia maps stored on the device (or downloaded from a server). Identifying the object most likely to be a television may provide far more accurate results then identifying what an unknown object most likely is, from among the whole universe of possible objects. An example scenario, e.g., a bug terminating scenario (described below), may then be played out on the television surface.

Due to the persistent and dynamic nature of the game, it may occur that a first user experiences an augmented reality object when logging into the game for the first time, while a second user does not experience the augmented reality object when logging into the game for the first time, even if the users log into the game at the same location. For example, if an augmented reality creature at the location when the first user logged into the game for the first time was subsequently destroyed prior to the logging into the game by the second user, the system may provide that the second user therefore does not experience the augmented reality creature. In an example embodiment, the system may provide for a modified version of the game history to be played for the first-time user. For example, although the creature may have been destroyed prior to the user's first log-in, the system may initially display the creature and then, for example, shortly thereafter, show the demise of the creature, which had previously occurred.

Next, a user may be given further tasks, and asked to find other items one may customarily find in a building. When all of the scenarios for a session have been accessed, at 540, the example method may wait for future scenario sets, which may include a single encounter, or another series of progressive scenarios.

Example Experience Scenarios: One example embodiment of the present invention may include a story-driven experience that provides a series of shorter goal-based experiences or scenarios.

In one example scenario, a user may be asked to point the device at a surface, e.g., a television. Once the example method identifies the relevant surface, an augmented reality may be formed with virtual devices. For example, virtual bugs may be interlaced on the television screen. A user may then have to deactivate those virtual bugs by following certain instructions, such as a specific order of tapping on the bugs. The touch screen display may work with the various other input/output devices and sensor data to receive input selecting a specific virtual bug. Output devices such as a vibration may be activated in response to each successful or alternatively, each unsuccessful deactivation. If the user fails the given task, a new scenario may begin in response. For example, if the bugs are not deactivated in the proper order, they may alert another character, and a scenario based on that character may begin. It may be that this second scenario is only reachable by failing the bug deactivation scenario, or to better utilize designed scenarios, the user may get to that scenario, or some similar variation, under a different pretext. For example, if the bugs are deactivated correctly, the user may be given other tasks to perform, and then be interrupted by the scenario with the other character anyway.

Another example scenario, independent or related to the other creature scenario described above, may include a subterranean creature. Here, the example method may determine when a smart device is sufficiently pointed down (e.g., in the same direction of gravity) via one or more included sensor devices (e.g., gyroscopes), and interlace a worm like creature to emerge and vanish into the flooring. The story-driven narration component may alert the user of this danger and activate a virtual tracking display (e.g., a radar-like screen), while providing instructions on how to defeat the danger. For example, the story narrator may provide the user with instructions to weaponize an item, like a pillow, and to toss the item at the creature. Here, it may be appreciated that the narration will naturally cause two things. First, the user will point the camera lens at the creature, and second, as a result, this may ensure the camera and display are pointed at the area the pillow will be thrown. The object recognition device then does not have to identify a pillow among other similar shapes, but may only have to perform a much easier task of recognizing the newly introduced moving object relative to the fixed landscape. Thus, again, the story-driven aspect ensures a higher success rate for the object recognition module of the example methods/devices. The AR may then interlace a virtual energy explosion, while animating the creatures destruction.

In another example of this scenario, which may also be implemented in other scenarios, the user may be informed of a series of steps to weaponize the user's arm/hand. The user may be instructed to bring the user's fist into view to activate a targeting assist mechanism, and point the user's fist at the creature. The AR may then identify the newly introduced object based on what a first person angle arm/fist should look like, and the context of such an object entering the field of view. The AR may then interlace virtual graphics on the user's fist, and provide an animated blast to the virtual creature, and render an animation of the creatures defeat.

Experiences are not confined to visuals. For example, a user may be informed of a series of steps to weaponize their lungs, in order to provide a freezing wind. The user may then hold the smart device in front of themselves to target a creature susceptible to freezing, and exhale deeply. The microphone may pick up the wind noise created, and interlace the appropriate AR graphics. Another example may inform the user that a particular creature's energy can be disrupted by a very specific tone. The smart device may provide a tuning instrument that illustrates a needle that moves about a target mark (e.g., at the proper tone) and instructs the user to hum or sing until they have achieved the proper tone. The appropriate AR graphics may be added or adjusted based on the tone and duration, etc.

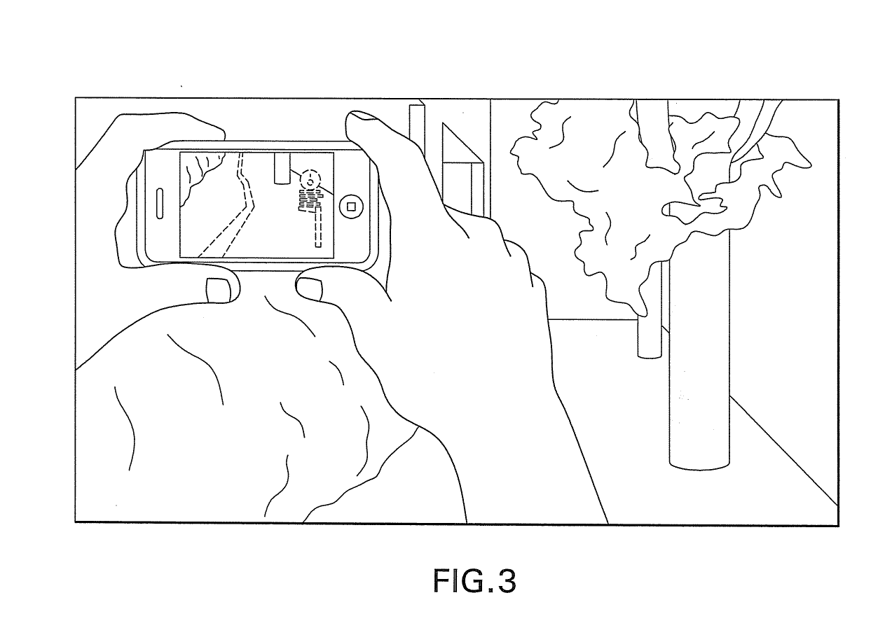

In another example scenario, a user may have to find a location using the smart device and following an AR marked trail. The trail may be established with a combination of object recognition, location sensing devices (e.g., cell triangulation, GPS, etc.), and map data. FIG. 3 illustrates one such example of this. In an example embodiment, the system may associate in memory animations with geographic coordinates. The animations may then be displayed in response to detection of the presence of the smart device at a location or proximal to the location having those geographic coordinates and/or of a particular viewing frustum of a camera of the smart device. For example, the animations may be displayed in response to detecting that the location having the geographic coordinates is viewable in the smart device. Moreover, the orientation in which the animations are displayed may depend on the orientation at which the location is viewable by the camera of the smart device.

In addition to or as an alternative to the illustrated trail, a user may be provided a series of clues along the way. This may be done by identifying objects and augmenting them into different objects. In this context, the AR may only need to identify a shape (e.g., small, long, curve-toped shape) to augment, without regard to exactly what the shape is (e.g., a parking meter or fire hydrant).

Clues may help form the path or provide side-experiences, e.g., opportunities for sub-adventures to acquire information, powers, weapons, tools, real-life coupons/money, game coupons/money, real objects, virtual objects, etc. Clues and marked paths may lead to single player adventures and goals, or may be used to bring together a group of players, from different starting points, to accomplish a group goal. For example, the story-narration may guide the user to a geographic location adjacent to a building with attributes known to the AR experience. The AR engine may then easily recognize markers on the known building, and provide a realistic virtual overlay based on those markers. The user and/or other users may see a virtual creature on the side of the building, and may be tasked with defeating the creature by performing a series of tasks and/or using the above mentioned virtual weapons.

Scenario clues may also be provided at various discrete times over an extended period of time. For example, a clue may be given during a movie preview, that is shown prior to another movie (which presents a revenue opportunity as players must attend the movie). The preview may appear totally normal, unless viewed through the smart device, which may replace certain scenes or objects with AR clues. Billboards, TV commercials, websites, store logos, or another other item/object may be replaced with a clue, which cumulatively may reveal a scenario and/or experience in the AR adventure.

Scenario clues may be provided based on single user goal completion and/or multi-user goal completion. For example, a clue may be unlocked when a plurality of users are each located in a specific location. The plurality of respective locations may be revealed by clues, AR markers/trails, or may be identified with more traditional information (e.g., an address or intersection). Game play may be geographically dispersed, such that example clues may be revealed when a user performs some task (e.g., standing in a specific location and/or doing some task) at Times Square in New York, while some other user performs some task at the Tower of London in the United Kingdom. Any number of other locations may be included, and the experience may select locations depending on the population of users in the area, in order to provide a high probability that at least one user in that area will participate.

User Created Experiences: Several user created experiences have already been described. For example, an experience created by users may occur naturally, as a consequence of system-use. When a first player interacts with a second player in trading, communicating, scenario playing, fighting, etc., this may be considered an experience at least partially created by users. Indirect experiences may be created by users. For example, a first group of users may claim control of a territory and may set up one or more defenses (e.g., a motion sensor weapon) to protect that area. This may be considered a user created experience for competing user groups who now must overcome the defenses to take or traverse the location. Additionally, users may create obstacle courses from parts of the real surroundings and AR items/obstacles. Obstacle courses may help teammates train and/or evaluate potential new members. Obstacle courses may be scored and scores reported with user permission (e.g., as a prerequisite to membership). Scenarios created by users may be made public as a form of competitive tournament, where high scores are recorded and distributed to scenario subscribers.

Other Example Features: Example embodiments of the present invention may include scenarios that include real actors. This real life character may include a number of things. For example, an actual actor may be hired to deliver clues, perform tasks/roles, and/or otherwise advance the storyline of the user experience. Alternatively or additionally, the real life actor may be an employee of a cross-promotion business. For example, an example scenario of the example experience may be generating revenue by running, a scenario designed to get players to a particular coffee chain. As part of the example experience, the particular coffee chain may task one or more employees at each location to play a real character role in the experience. This may be as simple as handing out clue cards or other tokens, or may be a more elaborate role, such as responding to a secret passphrase by acting as an undercover character of the experience. Alternatively or additionally, users and players may take on rolls within the scenario, as part of their experiences. When two users interact, they may simultaneously advance their own story-driven experiences while acting as an in-game character for the other user's story-driven experience and vice versa.

Supporting Content: The example experience may also provide supporting content. For example, in a secret operative scenario, there may be a normal website, which may be created for this purpose, or in an advertiser/partner arrangement, there may be a preexisting website (e.g., BrandName.com). The website may appear as normal, but when viewed through the AR smart device, or by knowing secret information gained during the AR experience, the user may see/find a button or log-in that is otherwise hidden. This may gain them access to an alliance website, where other supporting content is located.

Other supporting content may include videos, tutorials, training media, physical books, virtual books, digital books, etc. Each of these may have aspects or attributes that require the AR experience. Videos, pictures, books, etc., may have hidden images/messages. Likewise, videos may have hidden audio. Just as visual targets may help overlay an AR, audible targets (or visual) may help overlay an AR audio stream. For example, the smart device may receive via the microphone a video's audio track, which may trigger the speaker to output another audio track, which may be wholly separate, or may coincide with the video's audio track. Alternatively or additionally, an audio track may contain some light static or distortion, and may trigger the smart device narration to indicate a detected sub-signal. The smart device may then provide the user with filtering controls, and allow the user to try and isolate the sub-signal. An augmented audio output is then made from the smart device speaker in various permutations until a clear audio message is provided. This AR audio may provide instructions or information, or any number of other things AR video/graphics provide.

Supporting content may include movies, TV shows, websites, cartoons, videos, audio, or any number of other presentation items, and may help tell the story within the story-driven experience. These mini-stories may bridge one scenario to another with plot developing presentations, or may provide supplemental information/story to the overall experience. Supporting audio may be the primary AR function at times, or may play a supporting role at other times (e.g., beep and alert when an AR object is in near proximity).

Supporting content may also be produced by the game provider, based on the game experience. For example, a large multi-player operation may be planned for a certain area. The experience provider may place one or more fixed, robotic, and/or human operated cameras in the area. The experience may also record video images from the user's devices, and record high definition video of the scenario action. The experience provider may then edit together a multimedia presentation of the scenario, adding additional post-production graphics, and enhancing the real-time rendered graphics of the game. These videos may be provided as souvenirs to the users (for a fee or as part of other revenue generating operations). They may be provided as training videos in the hidden website or home command center. The video may be used along with other support content to create full length shows and/or movies to be released on TV/theaters, or via the internet.

Another benefit of video cameras provided by the experience providers may include virtual participants. A challenge of allowing users to participate in an AR scenario from their home desktop interface may be a lack of visual perspective. Onsite users may use their smart device camera to provide their visual perspective of the AR world. In one example embodiment, the onsite smart device video feeds may be fed to users at a desktop interface, where they may partner with the smart device user and provide assistance. However, the home user may be constrained by a lack of the home user's own fixed or controllable visual interface. However, with a provided camera, the video/audio feed may be fed to one or more desktop interface users. They may use the cameras to merely watch, or to watch and report. However, with their own visual perspective, they may also now participate in a number of ways.

One way may be to “deploy” their ally creature to assist in the scenario. With a fixed point camera they may not have a first-person perspective of their ally creature, but may have a visual presentation of that ally. They may then control the ally creature (graphic) inside the actual reality (video landscape), and interact with other users and/or AR creatures. Multiple cameras may be set up to facilitate control of ally movement over large areas (e.g., as the ally is made to move from one field of view to another, the video feed adjusts to a better camera angle). Cameras may also be set up, and scenario servers provided, such that the video feeds can be seamlessly compiled to provide a virtual camera that follows the ally creature around (e.g., similar to console video games).

Additionally or alternatively, fixed cameras may be established in key areas, and an AR entity may be rendered around those fixed positions. Onsite users may see (via their smart device camera) robotic cannons or other such tools. Users at their desktop interface may be able to tap into those robotic entities (e.g., having the visual perspective of the provided camera), and interact with the AR world (e.g., as rendered on their screen).

Scoring Metrics: Various leader boards may be maintained for certain scenarios and/or game accomplishments. These may be used within the game narration or apart from the game narration. For example, there may be competing “platoons” of users, and each platoon command center may keep statistics on both their soldiers/users and competing soldiers/users. In reality, the same data may be shared to create both data sets, and each data set may be enhanced with more information about the members of that platoon, as one would expect the platoon command to know more about its own soldiers than competing soldiers. Further, various tournaments or public events may be scored as part of the experience, with leader boards made available on a public forum, e.g., an AR sports broadcasting network. For example, SportsBroadcaster.com may partner with the experience provider to have an AR login portal where users may see stats from various AR events.

While many tasks and scenarios may primarily be accomplished via problem-solving, creativity, and other intellectual talents; physical metrics may also be recorded for accomplishments. A user may be required to run, while the fastest time is recorded/reported. A user may be required to play a virtual instrument and have the performance rated. A user may be required to play a real instrument, and the smart device microphone/processor may compare the performance to highly rated professional performances to rate it, or users can vote on each other's performances. Alternatively or additionally, the user may be required to sing and have that performance rated. These ratings may be recorded and kept on leader boards. The example experience may data mine user's profiles and surroundings to try and customize scenarios for the user. For example, if during the initial house scan a piano is identified, an example scenario requiring musical performance may provide a virtual piano and related task. Many of these tasks may be optional, since many players may not have the requisite ability, skill, or capacity to perform them.

Revenue Potentials: Example implementations include several opportunities to receive revenues for administering the game. One time, monthly, and/or per-use fees may be charged to users of the system. Brand partners may purchase in-game promotions, such as receiving a power-up by scanning a bar code hidden in a certain brand's packaging. Brand partners may purchase in-game advertising, such as having their billboard ad campaign trigger an AR advertisement overlay, which may draw added attention to their traditional campaign. Alternatively, brand partners may purchase an AR advertisement overlay for other traditional ads, even competitors' ads.

In-game scenarios may also drive real life traffic to retail establishments. For example, a major multiplayer mission may take place at a local mall. In-game clues or objects may be available from employees of a certain chain of retail establishments. Certain clues may be provided during a television advertisement, a television show, or a movie preview, when viewed through the smart device and AR engine. In some circumstances clues may be provided during a movie itself, which may provide advertising for both the AR experience and the advertiser, as half the theatre wonders why the other half all turned on their smart device LCDs at the same time.

Example Implementations: An example embodiment of the present invention is directed to one or more processors, which may be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The one or more processors may be embodied in a server or user terminal or combination thereof. The user terminal may be embodied, for example, a desktop, laptop, hand-held device, Personal Digital Assistant (PDA), television set-top Internet appliance, mobile telephone, smart phone, etc., or as a combination of one or more thereof. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape. Such devices may be used for running a central augmented reality game into which user devices may log, and may be used as user devices for logging into such a central server, outputting an augmented reality environment, and receiving input and/or sensing data used for interaction with and/or modification of the augmented reality environment.

An example embodiment of the present invention is directed to one or more hardware computer-readable media, e.g., as described above, having stored thereon instructions executable by one or more processors to perform the methods described herein.

An example embodiment of the present invention is directed to a method, e.g., of a hardware component or machine, of transmitting instructions executable by one or more processors to perform the methods described herein.

The above description is intended to be illustrative, and not restrictive. Those skilled in the art can appreciate from the foregoing description that the present invention may be implemented in a variety of forms, and that the various embodiments may be implemented alone or in combination. That is, features and embodiments described above may be combined and/or separated. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims, and it is contemplated to cover any and all modifications, variations, combinations, and equivalents that fall within the scope of the underlying principals disclosed and/or claimed herein.

What is claimed is:

1. A computer-implemented method for providing a gaming experience, the method comprising:
associating, by a processor, an element with geographic coordinates;
receiving data, by the processor and from a user device, the received data indicating that the user device is located proximal to a geographic location corresponding to the geographic coordinates; and
responsive to the received data, transmitting data, by the processor and to the user device, for rendering the element via an output device of the user device.

2. The computer-implemented method of claim 1, wherein the element is at least one of a sound, a text, and an image.

3. The computer-implemented method of claim 1, wherein:
the element is an animation element;
the output device is a display device; and
the rendering of the animation element includes displaying the animation element in the display device and one of (a) overlaying and (b) replacing a rendering of a real-space object that is at the geographic location and that is sensed by the user device.

4. The computer-implemented method of claim 3, wherein the animation element is displayed in the display device conditional upon that the geographic location is within a viewing frustum of an imaging sensor of the user device.

5. The computer-implemented method of claim 4, wherein the data received by the processor further indicates the viewing frustum, and the data for rendering the animation element is provided to the user device conditional upon that the geographic location is indicated to be within the viewing frustum.

6. The computer-implemented method of claim 4, wherein the data for rendering the animation element is transmitted to the user device when the data received by the processor from the user device indicates that the user device is within a predefined area drawn about the geographic location, prior to the geographic location being sensed by the imaging sensor, the user device locally storing the data for rendering the animation element and subsequently displaying the animation element in response to the imaging sensor sensing the geographic location.

7. The computer-implemented method of claim 4, wherein the viewing frustum is determined based on at least one of a sensed rotational position of the user device and recognition of an object sensed by the imaging sensor.

8. The computer-implemented method of claim 4, wherein the animation element is differently displayed depending on an angle of the user device relative to the geographic location.

9. The computer-implemented method of claim 3, wherein:
over time, the processor dynamically modifies animation elements to be associated with geographic coordinates, which geographic coordinates are associated with animation elements, and whether a user device receives data from the processor for displaying an animation element at a geographic location corresponding to particular geographic coordinates; and
which animation element the data includes for display at the geographic location corresponding to the particular geographic coordinates depends on a time at which the user device is indicated to be located proximal to the geographic location corresponding to the particular geographic coordinates.

10. The computer-implemented method of claim 9, wherein:
the processor is configured for a plurality of user devices located proximal to geographic locations corresponding to a particular set of geographic coordinates to log-in to the processor for obtaining data including animation elements associated with the set of geographic coordinates for display of the animation elements in respective display devices of the plurality of user devices;
the animation elements are provided by the processor as part of an interactive game in which players operating the user devices obtain at least one of points, ranking, and game currency during navigation of an augmented reality in which the animation elements are displayed in the display devices of the user devices;
a same animation element is provided to two or more of the plurality of user devices that are simultaneously positioned such that a geographic location corresponding to geographic coordinates with which the same animation element is associated is within respective viewing frustums of respective imaging sensors of the two or more of the plurality of user devices; and
due to the dynamic modification, for two or more user devices that begin the interactive game at different times at a same location with same viewing frustum, an animation element provided by the processor to one of the two or more user devices for one of (a) overlay over, and (b) replacement of, a real-space object at a geographic location within the same viewing frustum is not provided by the processor to another of the two or more user devices.

11. The computer-implemented method of claim 10, wherein the dynamic modification is responsive to player interaction with animation elements provided by the processor for display at user devices.

12. A computer-implemented method, comprising:
obtaining, by a processor, data from each of a first user device and a second user device, the data indicating that the first and second user devices are located proximal to each other; and
responsive to the obtained data, providing, by the processor, a gaming element for output at least one of the first and second user devices.

13. The computer-implemented method of claim 12, wherein the gaming element includes respective gaming elements for each of the first and second user devices representing a player associated with the other of the first and second user devices.

14. The computer-implemented method of claim 13, wherein the gaming element displayed in each of the first and second devices dynamically changes in response to real-space actions performed by the respective player with which the other of the first and second devices is associated.

15. The computer-implemented method of claim 12, wherein the gaming element is provided conditional upon that a user associated with the at least one of the first and second user devices has a specified status.

16. The computer-implemented method of claim 12, wherein the gaming element is provided conditional upon that a user associated with the at least one of the first and second user devices at least one of (a) has reached a predetermined game level and (b) is assigned to a specified team.

17. A computer-implemented method for providing a gaming experience, the method comprising:
associating, by a processor, an element with an object template; and
transmitting, by the processor and to a user device, data providing for output of the animation element in an output device of the user device responsive to matching of a real-space object to the object template.

18. The computer-implemented method of claim 17, wherein, the element is an animation element, the output device is a display device, the data provides for display of the animation element in the display device one of (a) overlaying and (b) replacing the real-space object matching the object template.

19. The computer-implemented method of claim 18, wherein the object template is one of a template of a furniture item, a template of a building, a template of an animal, a template of an outlet, a template of a lamp, a template of a person, and a template of sporting equipment.

20. A computer-implemented method for providing a gaming experience, the method comprising:
obtaining, by a processor of a user device, data that includes an element and that associates the element with an object;
outputting, by the user device, an instruction to move the user device such that the user device displays the object in a display device of the user device;
sensing, by the user device, movement of the user device subsequent to output of the instruction;
sensing, by the user device, that the user device has substantially come to a standstill subsequent to the sensed movement and that the user device remains substantially still for a predetermined time period; and
responsive to expiry of the predetermined time period, the processor outputs the element.

21. The computer-implemented method of claim 20, wherein the element is an animation element, the output of the animation element includes one of (a) overlaying the animation element over a focal feature that represents a sensed real-space object and that is displayed in the display device, and (b) replaces the focal feature with the animation element.

22. The computer-implemented method of claim 21, further comprising:
responsive to the expiry of the predetermined time period, the processor recording the focal feature in association with the animation element;
subsequent to the recordation, using object recognition to determine that a sensed real-space object matches the recorded focal feature; and
responsive to the determination of the match, one of (a) overlaying in the display device the animation element over a representation of the sensed real-space object determined to match the recorded focal feature, and (b) replacing in the display device the representation of the sensed real-space object determined to match the recorded focal feature with the animation element.

23. A computer-implemented method for providing a gaming experience, the method comprising:
obtaining, by a processor of a user device, data including an animation element that is associated with a sound;
sensing, by an imaging sensor of the user device, a real-space area;
responsive to the sensing of the real-space area, displaying in a display device of the user device a representation of the real-space area;
sensing, by the user device, the sound; and
responsive to the sensing of the sound, displaying, by the processor, the animation element in the display device and one of (a) overlaying and (b) replacing a portion of the representation of the real-space area.

24. A computer-implemented method for providing a gaming experience, the method comprising:
obtaining, by a processor of a user device and from a server, an element associated with geographic coordinates;
sensing, by the processor, that the user device is located proximal to a geographic location corresponding to the geographic coordinates; and
responsive to the sensing, outputting, by the processor, the element in an output device of the user device.

25. The computer-implemented method of claim 24, further comprising:
sensing, by the processor, that the user device is located proximal to a geographic location corresponding to the geographic coordinates;
wherein:
the element is an animation element;
the output device is a display device; and
the outputting includes displaying the animation element in the display device and one of (a) overlaying and (b) replacing a rendering of a real-space object that is at the geographic location and that is sensed by the user device.

26. The computer-implemented method of claim 25, further comprising:
providing a non-augmented reality based game for play on the user device; and
conditional upon at least one of (a) play of the provided non-augmented reality based game on the user device at least a predetermined number of times, (b) scoring at least a predetermined score by play of the provided non-augmented reality based game on the user device, and (c) reaching a predetermined level of the provided non-augmented reality based game on the user device, outputting on the user device a user-selectable link for joining an augmented-reality game in which the animation element is displayed, in which the processor dynamically changes display of animation elements as the user device changes location, and in which points are scored by a user performing a task also performed when playing the non-augmented reality based game.

27. The computer-implemented method of claim 25, wherein the data obtained from the server identifies the association of the animation element with the geographic coordinates.

28. A computer-implemented method for providing a gaming experience, the method comprising:
responsive to a combination of a sensed time of a clock and a sensed location of a user device, outputting, by a processor, an element in an output device of the user device.

29. The computer-implemented method of claim 28, wherein the element is an animation element, the output device is a display device, and the outputting includes displaying the animation element in the display device and one of (a) overlaying and (b) replacing a portion of a representation of a real-space area sensed by an imaging sensor of the user device.

30. The computer-implemented method of claim 29, wherein the clock is a clock of the user device.

31. The computer-implemented method of claim 29, further comprising:
recording an identification of a geographic location as a user home, wherein the display of the animation element is responsive to satisfaction of a condition that the sensed location is the geographic location identified as the user home.

32. A computer-implemented method for providing an augmented reality experience, comprising:
providing a story-driven augmented reality (AR) experience that includes a plurality of scenarios and objectives related to each other via the story-driven experience;
wherein the providing:
is on a smart device including a display, a processor, a memory, a network I/O device, an optical input device, and a plurality of sensor devices for sensing at least one of: position, altitude, angle, distance, movement, sound, and time; and
includes augmenting a display of a sensed image based on the at least one of the sensed position, altitude, angle, distance, movement, sound, and time.

33. The computer-implemented method of claim 32, further comprising:
providing an augmented reality ally with artificial intelligence as a graphical overlay to an image of a sensed generic physical form.

34. The computer-implemented method of claim 32, further comprising:
receiving input from a user defining a new scenario; and
providing the new scenario to a plurality of other users.

35. A computer-implemented method, comprising:
in accordance with user input at a first device associated with a first game player of a game, generating an interactive object;
obtaining and outputting, by a second user device associated with a second game player of the game, the interactive object; and
in accordance with interaction with the interactive object in accordance with user input at the second user device, modifying a game element of the second game player.

36. The method of claim 35, wherein the modifying the game element includes one of modifying a score of the second player, modifying a level of the second player, modifying a weapon of, or providing a weapon to, the second player, and modifying a tool or graphic object of, or providing a tool or graphic object to, the second player.

37. A computer-implemented method, comprising:
in accordance with user input at a first device, associating a sound with a location;
obtaining, by a second user device, the sound; and
outputting the sound, by the second user device, responsive to the second device reaching the location.
